(19) United States
(12) Patent Application Publication
(10) Pub. No.: US 2016/0280327 A1
(43) Pub. Date: Sep. 29, 2016

(54) SELF-POWERED GEAR SHIFT DEVICE FOR BICYCLES

(71) Applicant: XINET BIKE ENGINEERING SRL, ROVERETO (TRENTO) (IT)

(72) Inventors: CLAUDIO TISO, ALBIGNASEGO (IT); DAVIDE TISO, ALBIGNASEGO (IT)

(21) Appl. No.: 15/034,219

(22) PCT Filed: Nov. 6, 2014
(86) PCT No.: PCT/IB2014/065849

§ 371 Date: May 4, 2016

(30) Foreign Application Priority Data
Nov. 8, 2013 (IT) PD2013A000301

(51) Int. Cl. B62M 9/122; B62M 25/08; B62M 9/132

(52) U.S. Cl. CPC B62M 9/122; B62M 9/132; B62M 25/08

(57) ABSTRACT

The invention is a gear shift device for bicycles, comprising: gear shift control components (A1) suited to transmit codified and/or non-codified signals; actuator components (A3.1, A3.2) suited to be applied to the derailleurs (B4.1, B4.2) and suited to receive said signals and at least one management control unit (A2) of said signals. The device comprises a piece of equipment suited to generate electric energy for powering one or more of said control components (A1) and/or said unit (A2) and/or said actuators (A3.1, A3.2) and/or for charging/recharging one or more possible batteries.

This patent is related to bicycles and in particular concerns a new self-powered gear shift device for bicycles, with a system to recover energy which is dispersed or dissipated during the operation of the bicycle, to supply power to the device and/or to charge one or more batteries of the device.

Prior art includes bicycles with multiple gears comprising two or more toothed wheels side by side fixed to the rear wheel spindle, one or more toothed wheels fixed to the axle of the pedal cranks, a chain that engages a toothed wheel relative to the pedal cranks, and a toothed wheel on the rear wheel.

For each group of side by side toothed wheels, also called cassette of sprockets, there is a mechanism called a derailleur, controlled by the cyclist, which moves the chain, engaging it with one of the side by side toothed wheels. The rear derailleur moves the chain parallel to the axis of the wheel axle and the front derailleur moves the chain parallel to the axis of the pedal crank.

Currently derailleurs are controlled by levers or dials located on the handlebars near the handlebar grips or integrated into the handlebar grips and connected with the derailleur mechanisms themselves by sliding cables in sheathes, pipes or cable guides, which have many drawbacks: accumulation of dirt in the sheathes, obstructions, time and labour for installation, calibration operations, etc.

Prior art includes known systems for the electromechanical control of the derailleurs which comprise an electrical control, positioned on the handlebar grips or near the handlebar grips, connected by electrical cables with electromechanical actuators placed on or integrated with the derailleur mechanism.

These electromechanical control systems avoid the use of cables with a sheath but still require the passage of electric control wires.

These and other devices on the bicycle require electrical power. The use of batteries for this purpose is known in the art, but they involve numerous drawbacks: dimensions, weight, need for replacement and charging, as well as consequences for the environment, particularly as regards disposal processes.

Devices to recover electrical energy to produce electrical energy on the bicycle are also known in the prior art, such as the dynamo applied in contact with the rims of the wheels and which have the known drawback of generating resistance while pedalling.

To date there are no devices to recover the energy which is normally dissipated or dispersed during the operation of a bicycle.

Examples of energy usually dissipated or dispersed include, for example, the kinetic energy due to mechanical stresses and vibrations sustained by the bicycle during its movement, the thermal energy generated by the mechanical parts of the bicycle during its use, for example on the brakes or the tires of the wheels, the thermal energy generated by the cyclist, the eddy currents induced in the windings mounted on magnets set in motion due to moving metal parts of the bicycle.

The subject of the present patent is a new type of self-powered gear shift device for bicycles, with a system to recover energy which is dispersed or dissipated during the operation of the bicycle, to supply power to the device and/or to charge one or more batteries of the device.

The main task of the present invention is to have a self-powered device, where the electric energy for the power supply of the device is recovered from the energy dissipated or dispersed during the normal operation of the bicycle.

Another object of the present invention is to avoid the need for a connection to a power source or the replacement of batteries.

Yet another important object of the present invention is to directly power the circuit.

A further important object of the present invention is to be able to recover the excess energy generated, for example by charging one or more batteries. Still another object of this invention is to reduce the consumption of electricity required to send the command to shift the gear.

Another object of this invention is to also possibly exploit other sources of renewable energy to power the device and/or to charge one or more batteries thus limiting the environmental impact, since it limits the consumption of energy and solves the problem of the disposal of batteries.

These and other aims, direct and complementary, are achieved by the new self-powered gear shift device for bicycles, with a system to recover energy which is dispersed or dissipated during the operation of the bicycle, to supply power to the device and/or to charge one or more batteries of the device.

The present invention is suited to be installed on a bicycle and comprises in its main parts:
at least one gear shift control component of the bicycle, suited to transmit coded and/or uncoded signals;
one or more actuator components suited to be applied to the derailleurs and to receive the coded and/or uncoded signals;
at least one management control unit suited to receive signals from the control component, to process them and/or verify them, and to transmit them to the actuator devices;

and wherein the new device also comprises at least one unit suited to generate electricity, to directly or indirectly power one or more of the components and/or the management control unit, wherein the electrical energy is generated by recovering the energy dissipated or dispersed during operation of the bicycle.

This recovered electrical energy can also be used to charge/recharge one or more power supply batteries.

This at least one energy generation unit is integral to the bicycle itself, for example installed on the bicycle or connected to the cyclist.

Thus the intention is to use those forms of energy obtainable from alternative sources to generate electricity (“energy harvesting”), and more specifically, the intention is to recover the energy dispersed or dissipated during the operation of the bicycle and in particular: the kinetic energy due to mechanical stresses and vibrations sustained by the bicycle during its movement; the thermal energy generated by the mechanical parts of the bicycle during its use, for example on the brakes or the tires of the wheels; the thermal energy generated by the cyclist; and the eddy currents induced in the windings mounted on magnets set in motion due to moving metal parts of the bicycle.

Said power generation unit is particularly useful to directly power the bicycle's circuit during operation and/or stand by, and wherein, if there is excess energy generated, it is possible to envisage the use of one or more batteries or accumulators to store the excess energy produced.

Alternatively, this unit directly powers one or more batteries and, through these, the bicycle's circuit during operation and/or stand by.

The following is a description of the operation of the new device.

Preferably, the transmission/reception of the signals between the control component, the management control unit and the actuators is a wireless type, for example through radio communications and/or infrared devices and/or GPS devices and/or using mobile devices such as mobile phones, smartphones, tablets, or the like and/or through capacitive and/or inductive transmission.

In detail, this control component is for example suited to be fixed to the handlebar in the vicinity of a handlebar grip and preferably comprises at least two control buttons or levers.

In one possible embodiment, the command component comprises its own battery or accumulator, wherein the battery or accumulator is replaceable or rechargeable by connecting it to common battery charging devices. The battery or accumulator of the gear shift device is connected or suited to be connected to the electrical energy generation unit.

Alternatively the gear shift device can be directly connected or suited to be connected to the electrical energy generation unit.

In a preferred embodiment, the control component comprises at least one capacitively coupled transmitter and at least one inductively coupled transmitter.

The capacitive transmitter of the control component is suited to generate a coded signal for each button. In particular, the signals generated by the capacitive transmitter are input, by capacitive coupling, through the body of the cyclist.

The inductive transmitter of the first control component is suited to generate a coded signal for each button. In particular, the signals generated by the inductive transmitter are input, by inductive coupling, through the frame of the bicycle so that they can be detected at any metal point in the bicycle's frame.

Said management control unit is suited to be fixed to the bicycle frame or other parts. In the preferred embodiment, the management control unit is enclosed in a compact body and is suited to be fixed to the derailleur for example, preferably to the front derailleur.

The management control unit is also suited to be attached to any other part of the bicycle and connected to one or both of the actuators, with or without cables.

In a possible embodiment, the management control unit and at least one battery are integral and installed in a derailleur, preferably in the front derailleur.

In the preferred embodiment, the management control unit and at least one battery are integral and installed in at least one other place on the bicycle, preferably in proximity to or in correspondence with the central screw of the rear brake.

In a possible alternative embodiment, the management control unit and the control component can be integrated in a single compact body. In this embodiment, the buttons of the control component directly induce the management control unit to emit the corresponding coded signal.

Said management control unit in turn comprises, in the preferred embodiment, at least one control and command circuit, at least one capacitive receiver, at least one capacitive transmitter, at least one inductive receiver, and at least one inductive transmitter.

The management control unit may possibly comprise a battery or accumulator, wherein the battery can be separate from or joined to the management control unit. Alternatively, the management control unit is directly connected to the electricity generation unit.

Said possible battery or accumulator of the management control unit is preferably of the rechargeable type, connected or suited to be connected to the electricity generation unit.

Said management control unit is suited to receive and analyze the coded signals transmitted by means of capacitive coupling through the cyclist's body and by means of inductive coupling through the bicycle's frame and is suited in turn to transmit coded signals inductively coupled through the metal frame and capacitively coupled through the body of the cyclist himself.

The management control unit may comprise a GPS receiver, and/or a receiver of the speedometer of the wheel of the bicycle, and/or a position or tilt sensor, and/or a heart rate sensors receiver, and/or a WiFi transmitter/receiver, and/or a Bluetooth transmitter/receiver.

Each of the one or more actuator components is suitable to be applied to the relative derailleur mechanism or integrated into the derailleur mechanism. In the preferred embodiment, each of the actuator components comprises at least one capacitive receiver, at least one inductive receiver, and at least one mechanism with electric motor.

Each of the actuator components is suited to be connected to the electricity generation unit. Alternatively or in combination, each of the actuator devices may also comprise at least one battery or accumulator, wherein the battery or accumulator is preferably in turn connectable or connected to the electricity generation unit.

Each of the actuator components is suited to receive the coded signals transmitted by means of inductive coupling through the bicycle frame and by means of capacitive coupling through the body of the cyclist, and is suited to activate accordingly the derailleur to move the chain to the previous or subsequent sprocket.

Both the capacitive coupling and the inductive coupling preferably operate in the LF, MF, HF radio frequencies or in the frequency range between 10 kHz and 100 MHz.

The operation of the new self-powered gear shift device is as follows. The user, when he wants to change the gear, presses the appropriate button on the control component.

Consequently the control component issues a first coded signal, by means of capacitive coupling through the cyclist's body and/or by inductive coupling through the metal frame.

Said management control unit detects the coded signal, analyzes the correctness and applicability of the given command, and in turn issues a second coded signal, by means of capacitive coupling through the cyclist's body and/or by inductive coupling through the metal frame.

Each of the actuator components detects the first coded signal without performing any action. Each of the actuator components also detects the second coded signal, by means of capacitive receiver and/or inductive receiver, and activates the derailleur to move the chain to the previous or subsequent sprocket depending on the coded signal received.

It is possible to store some automatic operation parameters in the management control unit, coupled with slope and/or speed and/or geographic location and/or heart rate detectors, such as:
the automatic selection of the gear ratio to be used for the initial and/or final segment of the training;
the automatic selection of the gear ratio to be used in uphill and/or downhill segments, so as to maintain the cyclist's efforts constant;
the automatic selection of the gear ratio to be used for various segments, whether determined by mileage or time, as a function of the preset duration of the training session;
automatically changing the gear just before each climb;
the optimum combination of the toothed wheels of the rear wheel and the sprockets of the pedal cranks to obtain and/or maintain the desired gear ratio.

The new device may comprise a single control component, with a button or lever to increase the gear ratio, and a button or lever to reduce the gear ratio, and a single management control unit.

Alternatively, the new device may comprise a single control component integrated with the management control unit.

The new device comprises one or preferably two actuator components, each applied to or integrated with one of the derailleurs, front and rear.

By acting on the buttons of the control component, the management control unit decides and chooses which toothed wheels of the pedal cranks and the rear wheel are most suitable for the prior or subsequent gear ratio to the current one, and consequently sends a coded signal to each of the one or more actuators.

Each of the actuator components may control the activation of the derailleur upon the reception of the signal transmitted either through capacitive coupling and inductive coupling, or only upon the reception of the same signal transmitted by means of capacitive coupling and inductive coupling over a pre-established time period.

The new gear shift device for bicycles constructed in this way does not require the application and maintenance of cables, sleeves, returns, does not require the application and fixing of electrical wires and is also not affected by radio frequency interference that can be found during the ride.

Furthermore, the new bicycle gear shift device requires a limited consumption of energy to command the change of the gear ratio.

In addition, the electronic management control unit requires a minimum amount of energy in standby.

As noted, the new device comprises at least one electricity generation unit, suited to generate energy at zero cost to directly or indirectly power the management control unit and/or the control component and/or the actuators of the derailleurs and/or to recharge one or more of the batteries.

In particular, the power generation unit recovers the energy dissipated or dispersed during the operation of the bicycle, that is, the thermal energy generated by the cyclist or by the friction that occurs while the bicycle is in motion, and/or the kinetic energy resulting from the movement of the bicycle or the movement of bicycle parts.

In fact all devices that use non-renewable energy sources such as combustion engines, or devices that impede or restrict the operation of the bicycle, such as dynamos, which generate resistance in the pedal stroke, are excluded.

These devices are particularly suitable for the power supply of those electronic devices and components which operate at low voltage.

According to a first preferred embodiment, the new self-powered gear shift device comprises at least one electronic device of the piezoelectric type, suited to exploit the mechanical vibrations of the bicycle and/or parts of the bicycle while in motion, and/or the low-frequency vibrations and/or the movement of the cyclist and/or the vibrations of an acoustic origin, to generate electrical energy usable to power the device and/or charge/recharge one or more of the batteries.

Said piezoelectric device comprises for example a movable part suited to sustain the vibrations and a deformable portion connected to the movable part and wherein the vibrations induce deformations that generate electricity. Said piezoelectric electronic device can conveniently be installed in any part of the bicycle.

According to a further possible embodiment, the new gear shift device comprises at least one rotary magnetic device, which exploits the motion of parts of the bicycle to generate energy.

Said rotary magnetic device comprises, for example, at least one coil or winding, at least one permanent rotating magnet, for example housed on a pin, the device being housed in proximity to a moving metal part.

In the preferred embodiment, the rotary magnetic device is placed next to the chain, which serves as a movable part suited to put the magnet in rotation. Thus said rotary magnetic device can be installed for example in a derailleur or in any other position close to the chain.

In another possible embodiment, said rotary magnetic device is positioned in the vicinity of another moving part of the bicycle, such as the rim of a wheel or a pedal crank.

The rotation of the permanent magnet due to the movement of the nearby moving metal part generates an eddy current induced in the winding.

The energy generated can be used to supply power to the management control unit and/or the control component and/or one or more of the actuator components.

Alternatively or in addition to that, the energy can be used to charge/recharge one or more of the batteries.

Said rotary magnetic device can be installed as an alternative or in addition to the piezoelectric device.

Alternatively or in addition to the piezoelectric device and/or the rotary magnetic device, the new gear shift device may comprise a thermoelectric device, suited to exploit the thermal energy generated during operation of the bicycle, for example in the parts in which friction occurs, such as the brake shoes, or the thermal energy generated by the cyclist exerting himself.

For example, the thermoelectric device may comprise one or more Peltier cells installed on the bicycle, for example at the points that are heated by the cyclist, such as the seat or pedals or brake shoes, or installed on the cyclist's clothes such as parts of the riding suit or shoes. One of the two sides of the Peltier cell is heated to a greater extent than the other and the temperature difference which occurs between the two sides of the cell creates an electrical current that can be used to power the device and/or to charge/recharge one or more of the batteries.

In addition to one or more of the electrical energy generation units mentioned above, the gear shift device may also comprise one or more photovoltaic devices, comprising one or more photovoltaic cells that, installed on the bicycle or integral with the cyclist, in a position such as to be exposed to sunlight, generate electrical energy useful to power the device and/or to charge/recharge one or more of the batteries.

These photovoltaic devices can be fixed to the cyclist, for example, installed on the cyclist's riding suit or other garment.

The characteristics of the new self-powered gear shift device will be better clarified by the following description with reference to the drawings, attached by way of non-limiting example.

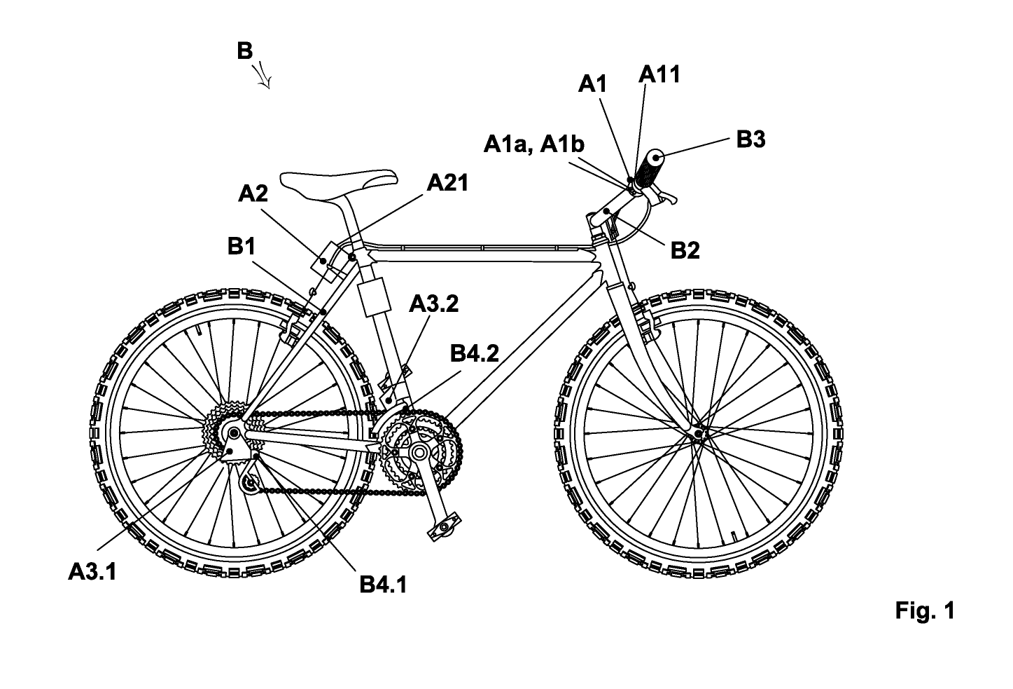

FIG. 1 shows a side view of a bicycle (B) on which the new self-powered gear shift device for bicycles is installed, whereas

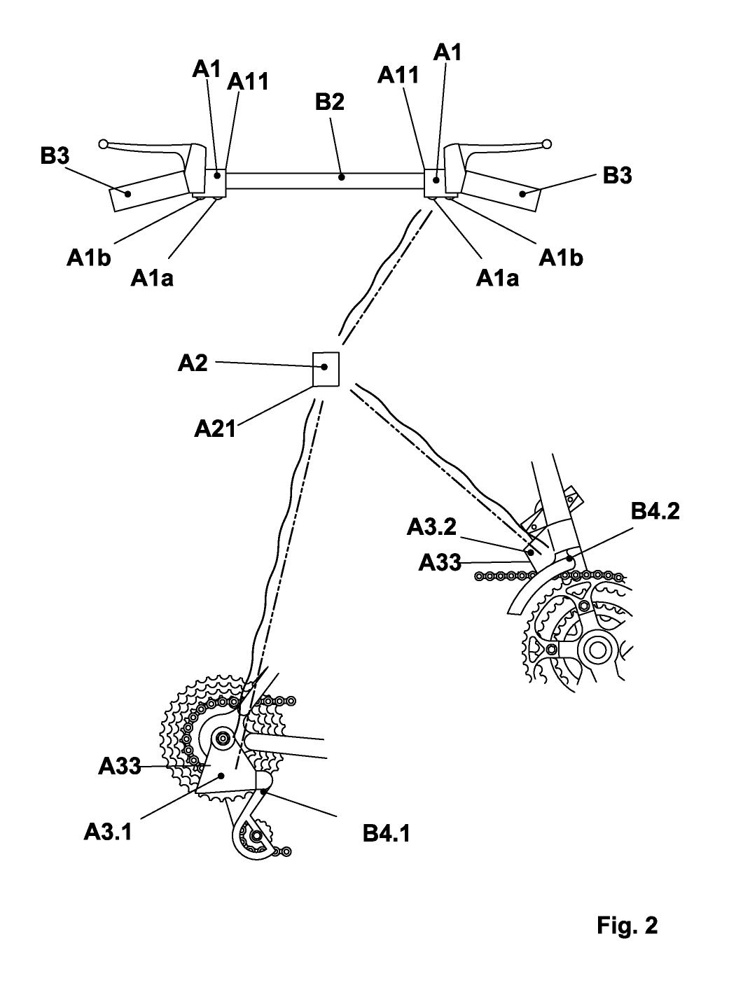

FIG. 2 shows the main parts (A1, A2, A3.1, A3.2) of the new device according to a first possible embodiment.

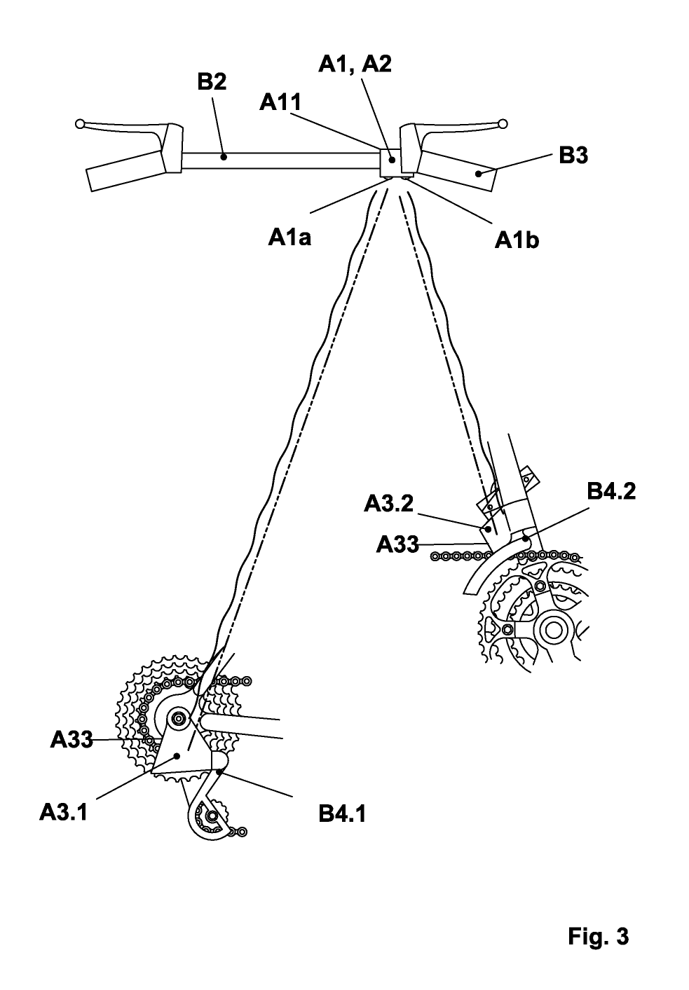

FIG. 3 shows the main parts (A1, A2, A3.1, A3.2) of the new device in a second possible embodiment.

The new self-powered gear shift device for bicycles comprises a control component (A1), a management control unit (A2), and two actuator components (A3.1, A3.2).

Said control component (A1) is for example suited to be fixed to the handlebar (B2) in the vicinity of a handlebar grip (B3) and in turn comprises at least two buttons or levers (A1a, A1b) and means for the wireless transmission of signals between the components. Preferably, the control component (A1) comprises at least one capacitive transmitter, at least one inductive transmitter. Said control component (A1) may also comprise at least one battery or accumulator (A11).

The capacitive transmitter and inductive transmitter of the control component (A1) generates a signal for each button (A1a, A1b).

Said management control unit (A2) is preferably fixed to the frame (B1) of the bicycle (B), for example preferably at the central screw of the rear brake, and comprises means for the wireless transmission of signals between the components. Preferably, the management control unit (A2) in turn comprises at least one control and command circuit, and at least one capacitive receiver, at least one capacitive transmitter, at least one inductive receiver, at least one inductive transmitter. The management control unit (A2) comprises at least one battery or accumulator (A21).

The management control unit (A2) receives and analyzes the signals transmitted by means of capacitive coupling and inductive coupling and in turn transmits signals by means of capacitive coupling and inductive coupling.

One of the actuator components (A3.1) is applied, or may be integrated, to the rear derailleur mechanism (B4.1), while the second actuator component (A3.2) is applied, or may be integrated, to the front derailleur mechanism (B4.2).

Each of the actuator components (A3.1, A3.2) comprises means for the wireless transmission of signals between the components. Preferably, the actuators (A3.1, A3.2) comprise at least one capacitive receiver, at least one inductive receiver, at least one mechanism with electric motor. The actuators (A3.1, A3.2) may comprise at least one battery or accumulator (A33) for each actuator (A3.1, A3.2).

Each of the actuators (A3.1, A3.2) receives signals by means of capacitive coupling and inductive coupling, and activates accordingly the corresponding derailleur (B4.1, B4.2) to move the chain to the prior or subsequent sprocket.

FIG. 3 shows the main parts (A1, A2, A3.1, A3.2) of the new device (A) in which the control component (A1) and the management control unit (A2) are integrated into a single object for example fixed to the handlebar (B2) in the vicinity of a handlebar grip (B3).

Therefore, with reference to the preceding description and the attached drawings the following claims are made.

1. Gear shift device for bicycles, comprising:
one or more gear shift control components (A1), suited to be applied to the frame (B1) of the bicycle and suited to transmit codified and/or non-codified signals;
one or more actuator components (A3.1, A3.2) suited to be applied to the derailleurs (B4.1, B4.2) and suited to receive the codified and/or non-codified signals transmitted by said control components (A1);
at least one management control unit (A2) of said codified and/or non-codified signals, characterized in that it also comprises at least one piece of equipment suited to generate electric energy for directly or indirectly supplying power to one or more of said control components (A1) and/or to said unit (A2) and/or to said actuators (A3.1, A3.2), said electric energy being obtained from the recovery of energy dissipated or dispersed during the operation of the bicycle, and wherein said at least one piece of equipment for generating energy is suited to be installed on the bicycle itself.

2. Gear shift device for bicycles according to claim 1, characterized in that said at least one piece of equipment for recovering electric energy from dissipated energy is used for charging/recharging one or more possible batteries for powering said control components (A1) and/or said unit (A2) and/or said actuators (A3.1, A3.2).

3. Gear shift device for bicycles according to claim 1, characterized in that said piece of equipment for generating energy comprises an electronic device of the piezoelectric type, suited to exploit the mechanical vibrations of the bicycle and/or of parts of the bicycle while the bicycle runs, and/or low frequency vibrations and/or the movement of the cyclist and/or vibrations of acoustic origin, in order to generate electric energy suited to be used to power the gear shift device and/or charge/recharge one or more of said batteries.

4. Gear shift device for bicycles according to claim 3, characterized in that said piezoelectric device comprises a moving part suited to be subjected to the vibrations and a deformable part connected to said moving part, and wherein the vibrations induce deformations that generate electric energy in said deformable part.

5. Gear shift device for bicycles according to claim 1, characterized in that said piece of equipment for generating energy comprises a rotary magnetic device that exploits the motion of parts of the bicycle to generate energy that can be used to power the gear shift device and/or charge/recharge one or more of said batteries.

6. Gear shift device for bicycles according to claim 5, characterized in that said rotary magnetic device comprises at least one coil or winding, at least one rotary permanent magnet housed in proximity to a moving metal part of the bicycle, and wherein the rotation of the permanent magnet due to the movement of the nearby moving metal part generates an induced eddy current in said winding.

7. Gear shift device according to claim 5, characterized in that said rotary magnetic device is placed in a position near the bicycle chain, which acts as a moving part during the use of the bicycle.

8. Gear shift device for bicycles according to claim 1, characterized in that said piece of equipment for generating energy comprises a thermoelectric device suited to exploit the thermal energy developed during the operation of the bicycle, like in the parts where considerable friction is developed, or the thermal energy developed by the cyclist making an effort, to generate electric energy that can be used to power the gear shift device and/or charge/recharge one or more of said batteries.

9. Gear shift device for bicycles according to claim 8, characterized in that said thermoelectric device comprises one or more Peltier cells installed on the bicycle in the areas where friction is generated and/or in the areas that are heated by the cyclist making an effort, like the saddle and/or the pedals and/or the brake pads, and/or installed on the cyclist's clothes such as parts of his/her cycling suit or shoes, wherein the generated heat heats one of the sides of the cell to a greater extent, and wherein the temperature difference that is produced between the two sides of the cell generates electric energy.

10. Gear shift device for bicycles according to claim 1, characterized in that it comprises one or more photovoltaic devices comprising one or more photovoltaic cells that, installed on the bicycle and/or integral with the cyclist in such a position as to be exposed to sunlight, generate electric energy that can be used to power said gear shift device and/or charge/recharge one or more of said batteries.

11. Gear shift device for bicycles according to claim 1, characterized in that it comprises means and/or devices for the wireless transmission of said signals among said control components (A1), said management unit (A2) and said actuators (A3.1, A3.2).

12. Gear shift device for bicycles according to claim 1, characterized in that said management unit (A2) is integrated in one of said actuator components (A3.1, A3.2) and installed in one of the two derailleurs (B4.1, B4.2) of the bicycle.

13. Gear shift device for bicycles according to claim 1, characterized in that said management unit (A2) is fixed to the frame (B1) of the bicycle (B).
